(19) United States
(12) Patent Application Publication
(10) Pub. No.: US 2016/0207361 A1
(43) Pub. Date: Jul. 21, 2016

(54) Bias-Or Radial-Carcass Tire

(71) Applicants: Herve FERIGO, Clermont-Ferrand Cedex 9 (FR); Hélène EMORINE, Clermont-Ferrand Cedex 9 (FR)

(72) Inventors: Herve FERIGO, Clermont-Ferrand Cedex 9 (FR); Hélène EMORINE, Clermont-Ferrand Cedex 9 (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 14/901,288

(22) PCT Filed: Jun. 26, 2014
(86) PCT No.: PCT/EP2014/063499

§ 371 Date: Dec. 28, 2015

(30) Foreign Application Priority Data
Jun. 28, 2013 (FR) 1356257

(51) Int. Cl. B60C 13/02; B60C 15/00; B60C 9/02; B60C 11/03; B60C 9/18

(52) U.S. Cl. CPC B60C 13/02; B60C 11/03; B60C 9/18; B60C 9/02; B60C 15/00; B60C 2011/0341

(57) ABSTRACT

Exterior surface of tire sidewalls have protuberances alternating with voids. The protuberances are arranged between points A, B and C, D. Point A is at the intersection of the radially exterior surface of the tire tread and of the sidewall. Radial axis ZZ′ is distant from equatorial plane AA′ by length L_{A} of between ½ (L−20 mm) and ½ (L−80 mm), L being the external section width. Point B is at a radius greater than or equal to [R₁+0.1 (R_{A}−R₁)] and less than R_{A}, R₁ being the radius at the external section width and R_{A} being the radius at the point A. Point C is at a radius less than or equal to [R₁−0.1(R₁−R₂)], R₂ being the radius of the top of the rim flange. Point D is at a radius in the range R₂<D<R₂+0.25(R₁−R₂).

The invention relates to cross-ply or radial tires.

Radial tires are gradually being imposed on various markets, notably the market for passenger vehicle tires. This success is due in particular to the endurance, comfort and low rolling resistance qualities that radial tires have to offer.

The main parts of a tire are the tread, the sidewalls and the beads. The beads are intended to come into contact with the rim. In a radial tire, each of the main parts of which the tire is made, namely the tread, the sidewalls and the beads, has functions that are clearly separated from one another, and therefore has a well known specific makeup.

A radial tire is essentially reinforced by a carcass reinforcement comprising at least one carcass ply set at an angle substantially equal to 90° with respect to the circumferential direction of the tire. This carcass reinforcement is surmounted radially on the outside, and under the tread, by reinforcing plies that form a belt.

A cross-ply tire differs from a radial tire in that there are at least two crossed plies set at angles other than 90° with respect to the circumferential direction of the tire. The plies are said to be “crossed” because the angles are of opposite sign from one ply to the other.

It will be recalled that, according to the invention, the circumferential direction of the tire is the direction in a plane perpendicular to the axis of rotation of the tire and tangential to the tire belt reinforcement.

After the emergence of radial tires, certain cross-ply tires were also provided with a belt reinforcement under the tread.

In both these types of tire, the tread, in direct contact with the ground, notably has the function of providing contact with the roadway and needs to adapt to the shape of the ground. The sidewalls themselves absorb the unevennesses of the ground by transmitting the mechanical forces required to support the load of the vehicle and allow it to move.

The belt reinforcement is a reinforcement which, on the one hand, needs to be sufficiently rigid with regard to edge deformations so that the tire can develop the cornering thrust necessary for steering, and transmit torque for traction or for braking and, on the other hand, be very soft in bending, which means to say allow variations in curvature in its plane in order to provide a sufficient area of contact of the tire with the ground.

As a result, the belt reinforcement generally has a composite structure allowing it to offer the required rigidity for a relatively low weight. The belt reinforcement is generally made up of at least two plies set at different angles, comprising reinforcers in the form of cords, coated with rubber. The reinforcer elements are crossed from one ply to the other with respect to the circumferential direction and may or may not be symmetric with respect to this direction.

Definitions:
“longitudinal or circumferential direction” is the direction of running of the tire,
“radial direction” is a direction that intersects the axis of rotation of the tire and is perpendicular thereto,
“axial direction” is a direction parallel to the axis of rotation of the tire,
“radially on the inside of” means closer to the axis of rotation,
“radially on the outside of” means further away from the axis of rotation,
“equatorial plane or midplane” means a plane perpendicular to the axis of rotation of the tire and which divides the tire into two substantially equal halves,
“transverse direction of the tire” means a direction parallel to the axis of rotation,
“radial or meridian plane” means a plane containing the axis of rotation of the tire.

Tires comprising sidewalls with external reinforcers which are intended to reduce the internal temperature at points on the tire that may deteriorate with use are already known from document JP2008068716 A.

However, the arrangement of these reinforcers on the sidewalls does not allow the sidewalls of a tire to be reinforced correctly for lateral knocks, such as kerbing (knocks against a kerb) or in potholes.

Indeed such knocks, which occur at various speeds and/or at various angles of attack, with conventional tire designs may cause damage, sometimes even going so far as to cause the tire to be scrapped.

Furthermore, the current trend towards the use of aluminium, rather than steel, rims in order notably to contribute to the overall aesthetic appearance of the vehicle has the consequence of causing the constituent parts of the crown reinforcement to break upwards of markedly lower speeds when the tire suffers lateral knocks.

Moreover, the current desire to use tires with increasingly short sidewall heights has, as yet another consequence, the fact that a knock to such sidewalls causes more intense degradation than it does with sidewalls that are taller, thus being more damaging to the tire.

A tire comprising protuberances that are discontinuous, along a radial axis, at the surface of the sidewall, the condition being that the combination of protuberances arranged on the radially lower part of the tire have a greater total surface area than those positioned on the radially upper part of the tire, so as to reduce the temperature of the tire when it is running, is also known from document EP 2 181 865 A1.

Document JP 60107402 describes the presence of elastomeric blocks on the tread, the shoulders and the sidewalls of a tire.

So, there is still a need to be able to improve still further the robustness of tire sidewalls with respect to lateral knocks, without thereby changing the current dimensions thereof.

One subject of the invention is therefore a tire for a rolling assembly comprising a rim and a tire, the said tire comprising at least one carcass reinforcement surmounted radially on the outside by a crown reinforcement, itself radially on the inside of a tread, the said crown reinforcement being made up of at least one layer of reinforcing elements, the said tread being connected to two beads by two sidewalls, the said beads being intended to come into contact with a rim having rim flange tops, each bead comprising at least one circumferential reinforcing element, the said sidewalls comprising, on their exterior surface, a series of protuberances alternating with voids, the said voids and the said protuberances each having a central axis.

The tire is characterized in that each protuberance is positioned at the surface of at least one sidewall regularly or irregularly and discontinuously between the points A and B and between the points C and D,
the said point A being arranged at the intersection of the radially exterior surface of the tread and of the sidewall, with a radial axis ZZ′ distant from the equatorial plane AA′ by a length L_{A} of between ½ (L−20 mm) and ½ (L−80 mm), L being the external section width,
the said point B being arranged at a radius greater than or equal to [R₁+0.1(R_{A}−R₁)] and less than R_{A}, R₁ being the radius at the external section width and R_{A} being the radius at the point A,
the said point C being arranged at a radius less than or equal to [R₁−0.1(R₁−R₂)], R₂ being the radius of the top of the rim flange, and
the said point D being arranged at a radius in the range

R₂<D<R₂+0.25(R₁−R₂).

The tire according to the invention has the advantage of being quick and easy to produce and of being able to withstand particularly violent lateral knocks without creating substantial damage that could possibly carry appreciable risk to the passengers of the vehicle.

The tire according to the invention also has the advantage of offering overall performance, such as rolling resistance, wear, endurance, that is equivalent to that of tires that have no protuberances on the sidewall.

Another subject of the invention is a rolling assembly comprising a rim and a tire as described hereinabove.

The term “regular” defines the fact that the protuberances arranged between the points A-B and C-D are arranged in alignment with one another in a radial direction, possibly with symmetry, and uniformly.

The term “irregular” means that the protuberances arranged between the points A-B and C-D are arranged with offset in two radial and parallel directions without symmetry and nonuniformly.

The term “discontinuously” defines the fact that the protuberances arranged between points A-B and C-D are arranged either in line with one another along a linear radial axis or along the same arc of a circle, or such that they are offset in two parallel radial directions or in two parallel arcs of a circle.

For preference, each protuberance is adjacent to a circumferential groove arranged at least at an axially outermost end of the said tread.

At least two adjacent or non-adjacent protuberances may enter a circumferential groove arranged at least at an axially outermost end of the said tread.

For preference, the combination of the protuberances arranged between points A and B have a greater surface area than the combination of the protuberances arranged between the points C and D.

The mean height of each protuberance may be between 3 and 10 mm and more preferably between 5 and 8 mm The mean height is defined as being the mean of the height comprised between the ends of a protuberance.

The protuberances may have a mean width of between 4 and 12 mm.

The protuberances may have a mean height greater than 80% of the maximum height over at least 80% of the length between the points A-B and C-D.

The protuberances preferably have a relief angle less than or equal to 20° and preferably of between 5 and 8°.

Two circumferentially adjacent protuberances may be spaced apart by a mean distance less than or equal to twice the mean width of a protuberance, and may be substantially parallel to one another.

The protuberances preferably cover at least 40% of the total circumferential surface area of the sidewall between the points A-B and C-D.

The protuberances have a first part P1 which extends from the point D to the point C, and a second part P2 which extends from the point B to the point A.

For preference, at least one protuberance comprises a central axis passing through a radially innermost end and through a radially outermost end of the said axis, the said axis being set at an angle β, with respect to the radial direction ZZ′, of between −60° and +60°.

The outboard sidewall of the tire (which is the one on the outside when mounted on the vehicle) and the inboard sidewall of the tire (which is the one on the inside when mounted on the vehicle) may each comprise protuberances with any possible combination of inclinations.

When tires according to the invention are mounted on a four-wheeled vehicle, the four tires may have inclinations that can vary according to each axle and/or that can vary on one and the same axle.

For preference, the void separating two circumferentially adjacent protuberances extends axially in the continuation of the void of a circumferential groove of the tread, passing through the point A, the said groove being arranged on at least one axial end of the tread. The axial end of the tread is also called the “shoulder” of the tire.

For preference, the void comprises a central axis which is set at an angle, to the circumferential direction, of between −15° and +15° in a region of the sidewall close to the point A, namely between 3 and 8 mm.

For preference, the sum of the width of the protuberances in the circumferential direction and in a radial plane between the points A-B and C-D is greater than or equal to 60% of the total circumferential length, the said length being measured at the location of the protuberances.

The tire preferably has a [sum of the total widths of all the protuberances]/[width of the sidewall without a protuberance] ratio greater than or equal to 30%, the surface areas of each protuberance being defined at 50% of the mean total height of the said protuberance.

The sidewall may be completely covered with protuberances.

The protuberances present on the sidewalls according to the invention are made of a material that is the same as that of the sidewalls.

The invention will now be described with the aid of the following examples of drawings that are given purely by way of illustration and in which:

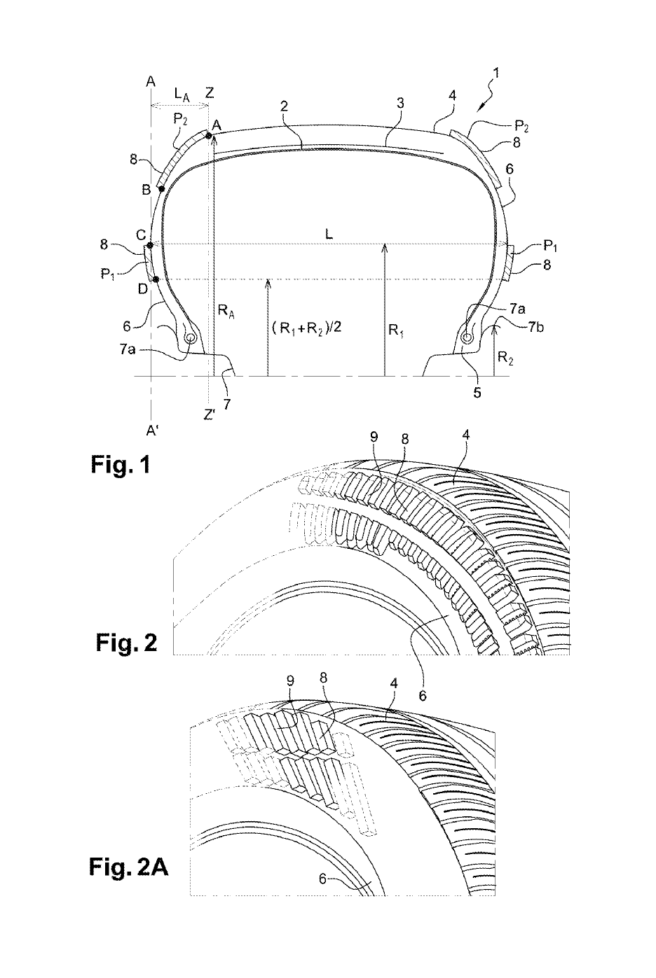

FIG. 1 schematically depicts a cross section on a radial plane through a tire according to the invention,

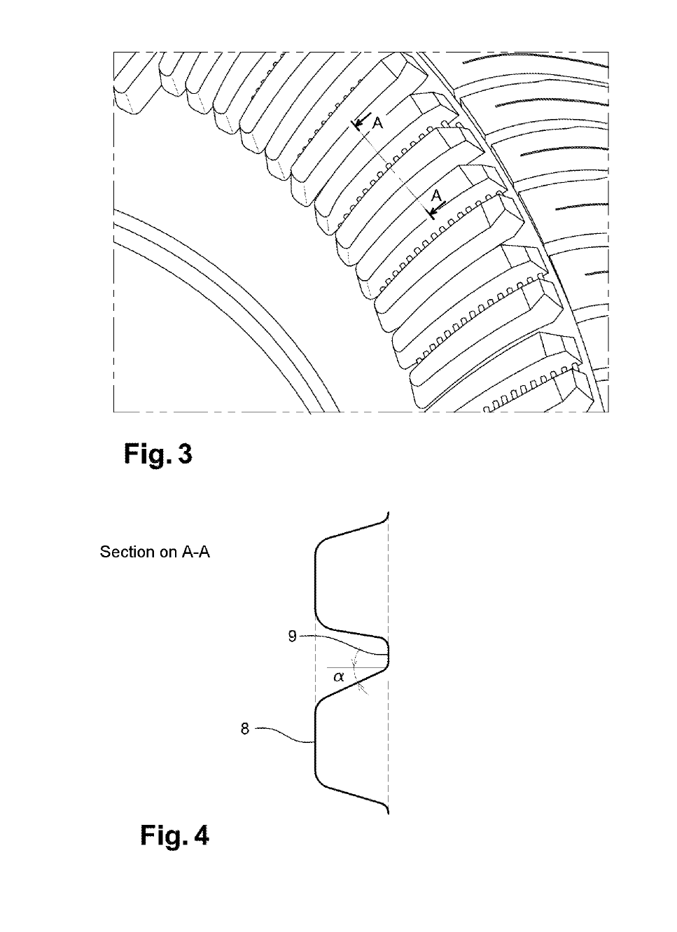

FIGS. 2 and 2A are three-dimensional schematic depictions of an enlarged portion of a sidewall and of the corresponding tread of a tire according to the invention,

FIG. 3 is a schematic depiction of a portion of a sidewall comprising protuberances of a tire according to the invention,

FIG. 4 is a view in section on AA of FIG. 3 showing two adjacent protuberances of a tire according to the invention,

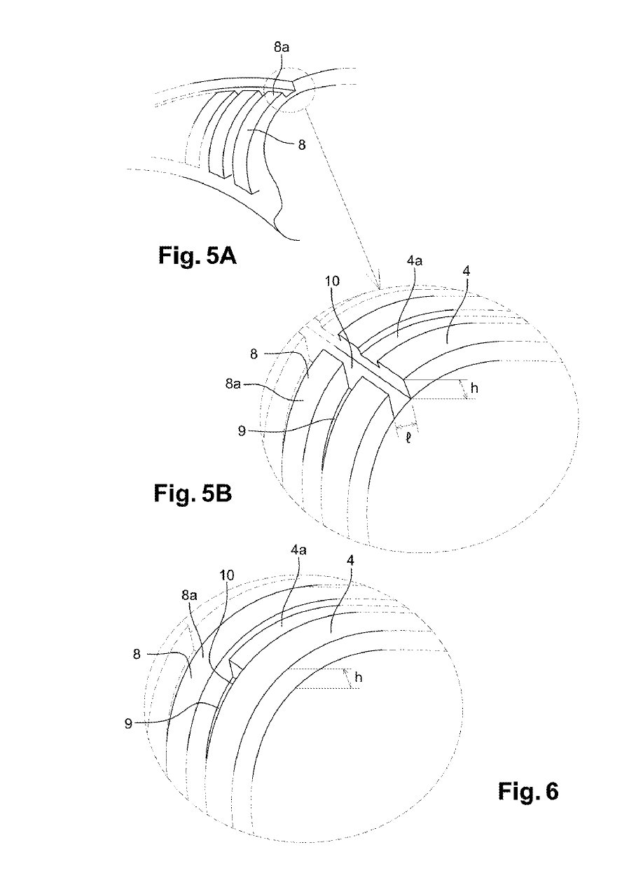

FIGS. 5A and 5B depict, according to a first alternative form, a portion of a radially exterior part of a sidewall and a corresponding tread part in three dimensions,

FIG. 6 depicts, according to a second alternative form, a portion of a radially exterior part of a sidewall and a corresponding tread part in three dimensions,

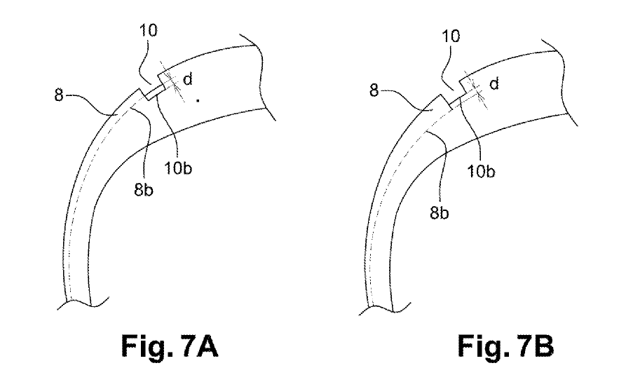

FIG. 7A depicts a partial view in radial section of a part of a sidewall and of a corresponding part of the tread according to another alternative form of a tire according to the invention,

FIG. 7B depicts a partial view in radial section of a part of a sidewall and of a corresponding part of the tread according to another alternative form of a tire according to the invention.

In the various figures, technical elements that are identical or similar bear the same references. So as not to overburden the text, their descriptions are not needlessly repeated.

As FIG. 1 shows, the passenger-vehicle tire of general reference 1 comprises a carcass reinforcement 2 radially on the inside of a belt reinforcement of overall reference 3, the said belt reinforcement 3 being radially on the inside of a tread 4 itself connected to two beads 5 by two sidewalls 6. The beads 5 are intended to come into contact with a rim 7 (partially depicted). Each bead comprises at least one circumferential reinforcing element 7a. On their surface, the sidewalls comprise a series of protuberances 8 regularly alternating with voids 9 (shown in FIG. 2).

FIG. 1 shows a protuberance 8 in cross section, this protuberance having a discontinuous length of neutral fibre.

It will be recalled here that a neutral fibre is the name given to a neutral axis that passes substantially through the centre of the volume of each protuberance and which neither shortens nor lengthens.

As FIG. 1 shows, the protuberances 8 are arranged, at the surface of the sidewall, over a discontinuous length of neutral fibre extending from a point A to B and from a point C to D.

It will be recalled that the external section width L is the section width of a tire mounted on the rim and inflated; the section width being, according to the invention, the distance between the outside of the sidewalls of an inflated tire, incorporating the sidewall surface relief.

The point A is arranged at the intersection between the radially exterior surface of the tread and of the sidewall, with an axis at zz′ distant from the equatorial plane by a length equal to 90 mm.

The point B is situated at a radius equal to 266 mm, point C at a radius equal to 258 mm, and point D at a radius equal to 238 mm for a tire of reference 205/5 R16 mounted on a 6.5 J 16 rim.

The protuberances are not inserted rubber elements added into the rubber of the sidewalls but are moulded in during the curing stage. They are obtained in a similar way to the tread patterns produced on the tread.

FIG. 2 depicts an alternation of protuberances 8 and of voids 9, represented in enlarged form in FIGS. 3 and 4. FIG. 2A depicts an alternative form of FIG. 2 in which the protuberances are set at an angle with respect to the axial direction. In this embodiment, the protuberances 8 are discontinuous and have a discontinuous neutral-fibre length of around 45 mm for part P1 (between C and D) and of 40 mm for part P2 (between A and B) for a tire of size 205/55 R 16. They are arranged substantially parallel to one another and are spaced apart by approximately 4.50 mm, have a height of approximately 6 mm and a width of approximately 8.6 mm in their axially innermost part.

The relief angle is approximately 8°. Such a value of relief angle allows the tire to be demoulded after curing without damage to the final structure.

According to this embodiment, the protuberances have a voids/solid surface area ratio equal to 40%, and are set at no angle with respect to the radial plane.

FIG. 5A is a three-dimensional depiction of the radially exterior part 8a of the protuberances 8 and FIG. 5B an enlargement thereof from FIG. 5A. In these FIGS. 5A and 5B, the part 8a of each protuberance 8 and the voids 9 are adjacent to a groove 10 arranged circumferentially on the surface of the tread 4 at the axially outermost end 4a thereof. The groove 10 is not interrupted in its length.

In this particular embodiment, the groove 10 has an axial width (l) along an axis YY′ that may be between 2 and 10 mm and a radial height “h” along the axis ZZ′ that may be between 3 and 8 mm.

FIG. 6 also shows a three-dimensional depiction of the radially exterior part 8a of the protuberances 8. Unlike in FIGS. 6A and 6B, the groove 10 is interrupted. Specifically, the end 8a of the protuberances 8 and the adjacent voids 9 intersect the groove 10 in the circumferential direction of the tire.

FIGS. 7A and 7B show that the radially interior portion 8b (depicted in dotted line) of the protuberance 8 is adjacent to the radially interior part 10b of the groove 10 with a distance “d” deviation of between 1 and 2 mm.

The tire according to the invention is obtained after curing and moulding in a curing mould in the conventional way.

### EXAMPLE 1

### Kerbing Test

This test was carried out with various tires compared to a control tire without protuberances.

The control tire does not comprise any protuberances.

The tire P1 comprises protuberances of discontinuous neutral fibre which are set at an angle of inclination with respect to the radial direction.

The “angle” column corresponds to the angle made by each protuberance with the radial direction of the tire.

The relief angle is the angle made by each end of a protuberance, as depicted in FIG. 5, intended to make same easier to demould.

The spacing of a protuberance is the distance between the centre of a first void and the centre of a second void adjacent to the first.

H (mm) is the mean height of the protuberances, l (mm) is the mean width of the protuberances.

R₁ is the radius at the external section width, R₂ is the radius at the top of the rim flange, Rₑ is the radius corresponding to the external section width L.

The external section width incorporating the reliefs comprises the external section width and the height of the protuberances present on the surface of the sidewalls.

Table I below collates the measurable technical features of various tires according to the invention.

TABLE I

| Tire | Control | P1 |
|---|---|---|
| Angle (degrees) | None | +60 |
| Protuberance relief | — | 9 |
| angle (degrees) | | |
| Protuberance height | — | 6 |
| H (mm) | | |
| Protuberance width | — | 10 |
| l (mm) | | |
| Protuberance neutral | — | 70 |
| fibre length (mm) | | |
| R₁ (mm) | 260 | 261 |
| R₂ (mm) | 220 | 220 |
| Rₑ (mm) | — | 224.1 |
| External section | 212 | 220 |
| width + relief (mm) | | |
| Offset | — | 5 |
| ‘Radius R’ (mm) | | 227.1 |
| Spacing (mm) | 0 | 15 |

This test was carried out under the following operating conditions.

The tire, mounted on a 6.5 J 16 rim and inflated to a pressure of 1.9 bar is fitted to the front right axle of a vehicle and supports a load of 350 kg.

The test consists in carrying out a knock against a kerb referred to as a “kerbing” of the tire against a metal block 90 mm tall, at an angle of 30° to the block with respect to the direction of running of the tire and at various speeds.

This test is carried out with a control tire (that has no protuberances) and with a tire according to the invention that comprises discontinuous protuberances that make an angle with the radial axis of the tire.

The results in table II below show the gain obtained in terms of speed, between a control tire (result equal to 100) and the tire according to the invention, before the tire punctures.

TABLE II

| Tire | Gain in speed (%) |
|---|---|
| Control | 100 |
| P1 | 125 |

The results in table II clearly show that the tire according to the invention, whatever the embodiment, provides a marked improvement in the speed with which the kerb can be hit before the tire punctures.

1. A tire for a rolling assembly comprising a rim and a tire, the tire comprising at least one carcass reinforcement surmounted radially on the outside by a crown reinforcement itself radially on the inside of a tread, said crown reinforcement being comprised of at least one layer of reinforcing elements, said tread being connected to two beads by two sidewalls, said beads being configured to come into contact with a rim having rim flange tops, each bead comprising at least one circumferential reinforcing element, said sidewalls comprising, on their exterior surface, a series of protuberances alternating with voids, said voids and said protuberances each having a central axis, wherein each said protuberance, of defined or arbitrary geometric shape, is positioned at the surface of a said sidewall, the various protuberances being arranged regularly or irregularly and discontinuously between the points A and B and between the points C and D,
said point A being arranged at the intersection of the radially exterior surface of the tread and of the sidewall, with a radial axis ZZ′ distant from an equatorial plane AA′ by a length L_{A} of between ½(L−20 mm) and ½ (L−80 mm), L being the external section width,
said point B being arranged at a radius greater than or equal to [R₁+0.1(R_{A}−R₁)] and less than R_{A}, R₁ being the radius at the external section width and R_{A} being the radius at the point A,
said point C being arranged at a radius less than or equal to [R₁−0.1(R₁−R₂)], R₂ being the radius of the top of the flange, and
said point D being arranged at a radius in the range
R₂<D<R₂+0.25(R₁−R₂).

2. The tire according to claim 1, wherein each protuberance is adjacent to a circumferential groove arranged at least at an axially outermost end of the said tread.

3. The tire according to claim 1, wherein at least two adjacent or non-adjacent protuberances enter a circumferential groove arranged at least at an axially outermost end of the said tread.

4. The tire according to claim 1, wherein the combination of protuberances arranged between the points A and B have a greater surface area than the combination of protuberances arranged between the points C and D.

5. The tire according to claim 1, wherein each said protuberance has a mean height of between 3 and 10 mm.

6. The tire according to claim 1, wherein each said protuberance has a mean width of between 4 and 12 mm.

7. The tire according to claim 1, wherein the mean height of each said protuberance is between 5 and 8 mm.

8. The tire according to claim 5, wherein each said protuberance has a mean height greater than 80% of the maximum height over at least 80% of the length between the points A-B and C-D.

9. The tire according to claim 1, wherein each said protuberance has a relief angle a less than or equal to 20° and preferably of between 5 and 8°.

10. The tire according to claim 1, wherein two circumferentially adjacent said protuberances are spaced apart by a mean distance less than or equal to twice the mean width of a said protuberance.

11. The tire according to claim 1, wherein two said protuberances are separated by a mean length less than or equal to twice the mean width of a protuberance and are substantially parallel to one another.

12. The tire according to claim 1, wherein the protuberances cover at least 40% of the total circumferential surface area of the sidewall between the points A-B and C-D.

13. The tire according to claim 1, wherein at least one said protuberance has a central axis passing through a radially innermost end and through a radially outermost end of the said axis, said axis being set at an angle β, with respect to the radial direction ZZ′, of between −60° and +60°.

14. The tire according to claim 1, wherein the void separating two circumferentially adjacent said protuberances extends axially in the continuation of the void of a circumferential groove of the tread, passing through the point A, said groove being arranged on at least one axial end of the tread.

15. The tire according to claim 1, wherein the void comprises a central axis which is set at an angle, to the circumferential direction, of between −15° and +15° in a region of the sidewall close to the point A.

16. The tire according to claim 1, wherein the sum of the width of the protuberances, in the circumferential direction, between the points A-B and/or C-D is greater than or equal to 60% of the total circumferential length.

17. The tire according to claim 1, wherein the tire has a [sum of the total widths of all the protuberances]/[width of the sidewall without a protuberance] ratio greater than or equal to 30%, the surface areas of each protuberance being defined at 50% of the total height of the said protuberance.

18. The tire according to claim 17, wherein the ratio is equal to 60%.

19. The tire according to claim 1, wherein the sidewall is covered with said protuberances.

20. A rolling assembly comprising a rim and a tire according to claim 1.
